(19) United States
(12) Patent Application Publication
(10) Pub. No.: US 2015/0302840 A1
(43) Pub. Date: Oct. 22, 2015

(54) WEARABLE DEVICE SYSTEM FOR GENERATING AUDIO

(71) Applicant: Adam Button, Pacific Palisades, CA (US)

(72) Inventor: Adam Button, Pacific Palisades, CA (US)

(21) Appl. No.: 14/690,244

(22) Filed: Apr. 17, 2015

Related U.S. Application Data
(60) Provisional application No. 61/981,206, filed on Apr. 18, 2014.

(51) Int. Cl. G10H 1/00; G06F 3/16

(52) U.S. Cl. CPC G10H 1/0083; G06F 3/165; G10H 2220/201

(57) ABSTRACT

A wearable device worn on one or more fingers of user may be used to generate audio content. The wearable device may include one or more bands worn on a finger of a user, wherein each ach band includes motion detection components. The motion detection components are coupled to transmission components which send motion detection signals with movement data to an external device. The external device, for example a mobile device or headset, receives the signals, creates an audio signal in response to the signal and outputs the audio. The external device may provide the generated audio concurrently while providing an audio file such as music. While a user is listening to the music, the user may move his or her fingers, each finger including a band, to generate a variety of sounds, such as a sound from musical instrument such as a drum or guitar.

### CROSS-REFERENCE TO RELATED APPLICATIONS

This application claims the priority benefit of U.S. Provisional Application Ser. No. 61/981,206, titled “Wearable Device System for Generating Audio,” filed Sep. 18, 2014, the disclosure of which is incorporated herein by reference.

### BACKGROUND

Wearable devices are typically worn on the wrist and communicate with a mobile device such as smart phone. Most wearable devices collect information such as how many steps a user takes or other user data. The wearables are typically bulky and are worn around the users wrist or arm and transmit data to the mobile device. These devices serve a purpose to a user's health, but are limited in the data they can provide and do not provide much entertainment value. What is needed is an improved wearable system for providing entertainment value to a user.

### SUMMARY

The present technology includes one or more bands worn on one or more fingers of user and used to generate audio content. Each band includes motion detection components and includes or is connected to transmission components which send motion detection signals to an external device. The external device, for example a mobile device, headset or other device capable of wireless communication, receives the signals, creates an audio signal in response to the signal and outputs the audio signal.

In some embodiments, the external device may provide the generated audio concurrently while providing an audio file such as for example an mp3 music file. While a user is listening to the song, the user may move his or her fingers, each finger including a band, to generate a variety of sound. For example, the sound may be from a musical instrument such as a drum or guitar. In this manner, a user may move his or her fingers to provide “air drums” or “air guitar” to play during playback of an audio song.

In embodiments, a system for generating audio may include a wearable device, a communication component and an audio generator. The wearable component may be worn on a user's finger and include a motion detection component. The motion detection component may detect motion by the user's finger and generate movement data. The communication component may receive the movement data from the motion detection component and transmit the movement data to the audio generator. The audio generator may generate audio in response to receiving the movement data.

### BRIEF DESCRIPTION OF THE DRAWINGS

FIG. 1 is a block diagram of a system including a wearable device.

FIG. 2 is a user's hand with bands over the user's fingers.

FIG. 3 is a block diagram of a wearable device.

FIG. 4 is a method of operation for a wearable device.

FIG. 5 is a block diagram of a computing system for implementing the present technology.

FIG. 6 is a block diagram of a mobile device system for implementing the present technology.

### DETAILED DESCRIPTION

The present technology includes one or more bands worn on one or more fingers of user and used to generate audio content. Each band includes motion detection components and includes or is connected to transmission components which send motion detection signals to an external device. The external device, for example a mobile device, headset or other device capable of wireless communication, receives the signals, creates an audio signal in response to the signal and outputs the audio signal.

In some embodiments, the external device may provide the generated audio concurrently while providing an audio file such as for example an mp3 music file. While a user is listening to the song, the user may move his or her fingers, each finger including a band, to generate a variety of sound. For example, the sound may be from a musical instrument such as a drum or guitar. In this manner, a user may move his or her fingers to provide “air drums” or “air guitar” to play during playback of an audio song.

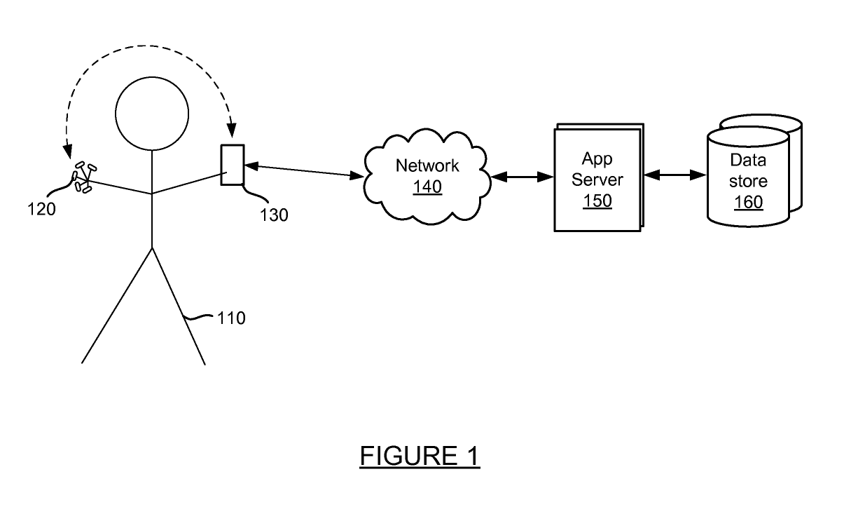

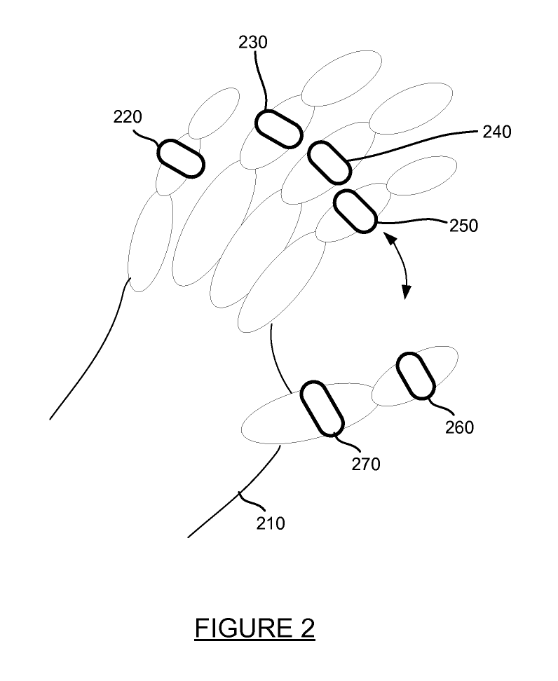

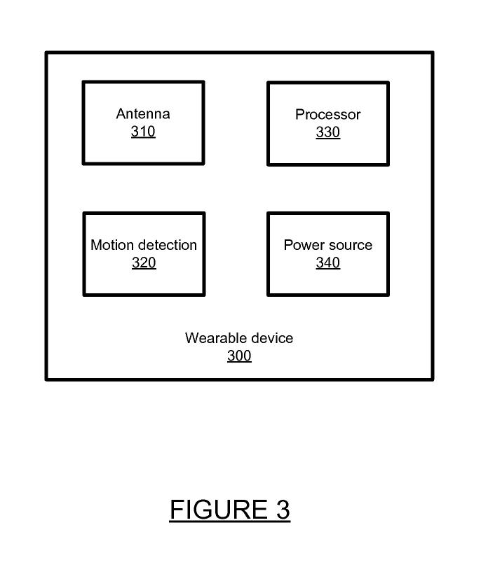

FIG. 1 is a block diagram of a system including a wearable device. The system of FIG. 1 includes wearable device 120, mobile device 130, network 140, application server 150, and data store 160. The wearable device 120 may include one or more bands worn on the fingers of a user 110. The wearable device may also include circuitry and/or components for generating signals to transmit wirelessly, transmitting and receiving signals, and other components. For example, the wearable device may communicate signals that include movement data to mobile device 130. The movement data may indicate what band was detected to have moved, in what direction the band moved, how far or over what range the band moved, and the movement velocity and acceleration. Wearable device 120 is discussed in more detail below with respect to FIGS. 2 and 3.

Mobile device 130 may communicate with the wearable device 120 as well as network 140. Mobile device 130 may include one or more applications which receive signals and data output by wearable device 120, process the signals, generate an audio signal, and output that audio signal through an output component of mobile device 130. In some embodiments, device 130 may be a mobile device such as a smart phone or tablet computer, or may include a headset or other device configured to output audio.

Network 140 may include one or more networks over which device 130 may communicate with application server 150. Network 140 may include an intranet, the internet, a public network, a private network, a local area network, a wide area network, a wireless network, a Wi-Fi network, a cellular network, or other type of networks suitable for communicating digital information. In some embodiments, network 140 may include one or more of these mentioned networks.

Application server 150 may communicate with mobile device 130 over network 140. In some embodiments, application server 150 may include one or more network servers as well as one or more application servers and may be used to store data associated with a user's preference or use of wearable device 120 as communicated through an application or other code on device 130. Application server 150 may communicate and store data with data store 160. Data store 160 may include user account information, passwords, settings, parameters and preferences for using the wearable device 120, and other data.

FIG. 2 is an illustration of a user's hand with one or more bands making up part of a wearable device. The user's hand 210 may include bands 220, 230, 240, 250, 260 and 270. As shown, when a user moves a finger, such as that wearing band 250, motion detection components in the band may detect the level of movement within the hand. In some embodiments, the level of motion detected may include the direction, range of motion, and other aspects of the motion. The wearable device may include bands 220-270 as well as other components that may power the bands, transmit motion detection signals, and other data. When motion is detected by a band, a signal may be generated regarding the motion and may be transmitted to mobile device 130.

FIG. 3 is a block diagram of a wearable device. Wearable device 300 may include an antenna 310, motion detection components 320, processor 330, and power source 340. Antenna 310 may send and receive wireless signals with mobile device 130 or another device which receives motion detection information from the wearable device.

Motion detection 320 may be implemented on one or more of the bands worn by a user and may detect one or more parameters of motion incurred by the bands. For example, motion detection 320 may include an accelerometer, gyroscope, or other motion detection mechanism for detecting when a user's finger which wears a band moves. Motion detection mechanism 320 may, in response to detecting movement, generate a movement signal and provide the signal to processor 330. Processor 330 may prepare an output signal for transmission over antenna 310 based on the motion detection signals received from motion detection module 320. Power source 340 may include a battery and may provide power to antenna 310, motion detection 320, and processor 330.

In some instances, each band such as that illustrated in FIG. 2 may include each component illustrated in FIG. 3. In some instances, each band may include a portion for the components, such as for example the motion detection components, and may be coupled to the other components. For example, the bands may detect the motion and communicate to a processor and Bluetooth transmission component located on a glove or other article worn by the user and in communication with the bands.

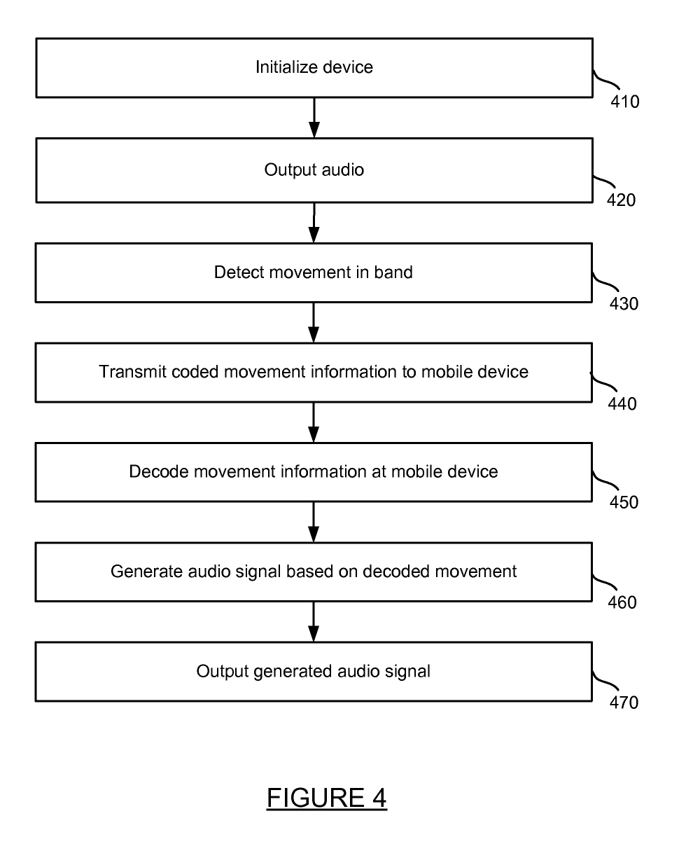

FIG. 4 is a method for operating a wearable device. First, the device may be initialized at step 410. Initializing the device may include setting parameters regarding how many bands will be used within the device, what audio signals to generate in response to detected movement, the range of movement for triggering a motion detection signal, user account information associated with the wearable device, and other initialization and configuration tasks. After initializing the device, an audio file may be output by the system at step 420. In some embodiments, an initial audio file may be output for listening by the user. As the user listens to that audio file, the user may move his or her hands to generate motion signals which correspond to audio signals that will be generated by the system. In this manner, a user may trigger the generation of musical instrument sounds to accompany the audio file output at step 420. In particular, a user may generate drum sounds, guitar sounds, or other sounds to playback along with the audio file output at step 420.

Movement is detected in the wearable device bands at step 430. The movement may be detected in one or more directions and in one or more increments, such as 10 degrees, 20 degrees, 30 degrees or some other range. The movement may be detected by bands which include accelerometers, gyroscopes, or some other motion detection mechanism in a band of the wearable device. Coded movement information may be transmitted to the mobile device by the wearable device at step 440. The coded movement may be generated by the processor in response to receiving a movement generation signal from a movement component within the wearable device. The coded movement may be provided by a processor to an antenna and transmitted by the antenna to a mobile device, headset, or other device which provides audio to the user.

The coded movement information is received and decoded at a mobile device (or other device) at step 450. The movement information may be decoded, for example by transforming the data from analog to digital format, or some other decoding. An audio signal is then generated based on the decoded movement information at step 460. Once the audio signal is generated, the audio may be output by the device 130 at step 470. The output generated at step 470 may be provided to a user along with the audio file provided at step 420 so that the user may hear both audio files at the same time.

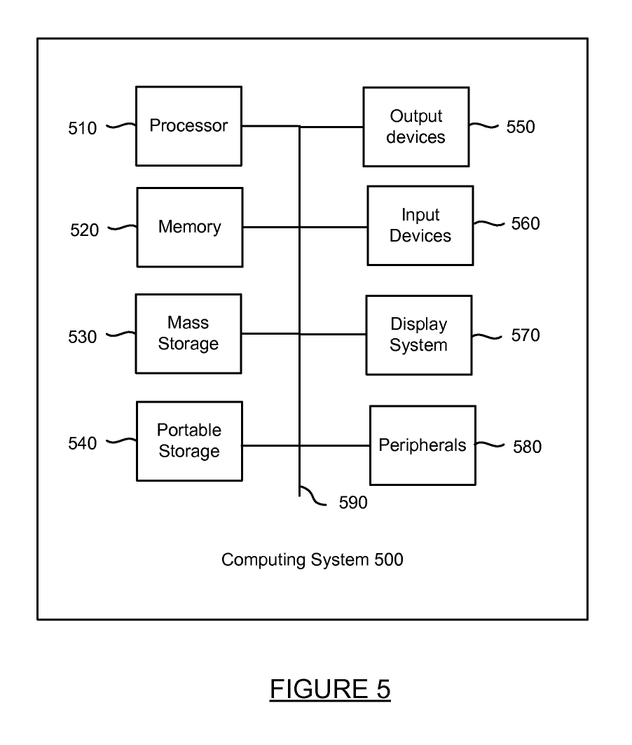

FIG. 5 illustrates an exemplary computing system 500 that may be used to implement a computing device for use with the present technology. System 500 of FIG. 5 may be implemented in the contexts of the likes of server 150 and data store 160. The computing system 500 of FIG. 5 includes one or more processors 510 and memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

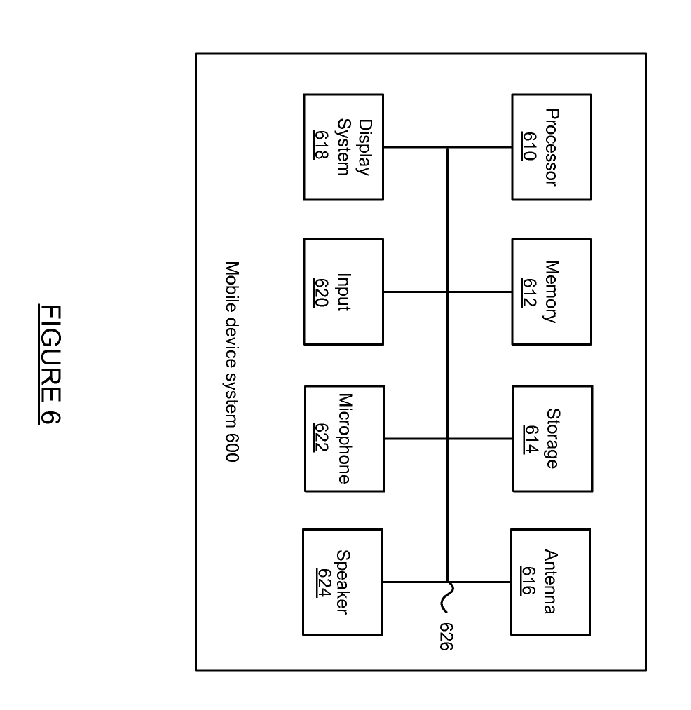

FIG. 6 illustrates an exemplary mobile device system 600 that may be used to implement a mobile device for use with the present technology, such as for device 130. The mobile device system 600 of FIG. 6 includes one or more processors 610 and memory 612. Memory 612 stores, in part, programs, instructions and data for execution and processing by processor 610. The system 600 of FIG. 6 further includes storage 614, one or more antennas 616, a display system 618, inputs 620, one or more microphones 622, and one or more speakers 624.

The components shown in FIG. 6 are depicted as being connected via a single bus 626. However, the components 610-624 may be connected through one or more data transport means. For example, processor unit 610 and main memory 612 may be connected via a local microprocessor bus, and storage 614, display system 618, input 620, and microphone 622 and speaker 624 may be connected via one or more input/output (I/O) buses.

Memory 612 may include local memory such as RAM and ROM, portable memory in the form of an insertable memory card or other attachment (e.g., via universal serial bus), a magnetic disk drive or an optical disk drive, a form of FLASH or PROM memory, or other electronic storage medium. Memory 612 can store the system software for implementing embodiments of the present invention for purposes of loading that software into processor 610.

Antenna 616 may include one or more antennas for communicating wirelessly with another device. Antenna 616 may be used, for example, to communicate wirelessly via Wi-Fi, Bluetooth, with a cellular network, or with other wireless protocols and systems. The one or more antennas may be controlled by a processor 610, which may include a controller, to transmit and receive wireless signals. For example, processor 610 may execute one or more stored programs to send and receive wireless signals with a cellular network via antenna 616.

Display system 618 may include a liquid crystal display (LCD), a touch screen display, or other suitable display device. Display system 618 may be controlled to display textual and graphical information and output to text and graphics through a display device. When implemented with a touch screen display, the display system may receive input and transmit the input to processor 610 and memory 612.

Input devices 620 provide a portion of a user interface. Input devices 620 may include an alpha-numeric keypad, such as a keyboard, for inputting alpha-numeric and other information, a touch-screen, microphone, camera, buttons or switches, a trackball, stylus, or cursor direction keys.

Microphone 622 may include one or more microphone devices which transmit captured acoustic signals to processor 610 and memory 612. The acoustic signals may be processed to transmit over a network via antenna 616.

Speaker 624 may provide an audio output for mobile device system 600. For example, a signal received at antenna 616 may be processed by a program stored in memory 612 and executed by processor 610. The output of the executed program may be provided to speaker 624 which provides audio. Additionally, processor 610 may generate an audio signal, for example an audible alert, and output the audible alert through speaker 624.

The mobile device system 600 as shown in FIG. 6 may include devices and components in addition to those illustrated in FIG. 6. For example, mobile device system 600 may include an additional network interface such as a universal serial bus (USB) port.

The components contained in the mobile device system 600 of FIG. 6 are those typically found in mobile device systems that may be suitable for use with embodiments of the present invention and are intended to represent a broad category of such mobile device components that are well known in the art. Thus, the mobile device system 600 of FIG. 6 can be a cellular phone, smart phone, hand held computing device, minicomputer, or any other computing device. The mobile device can also include different bus configurations, networked platforms, multi-processor platforms, etc. Various operating systems can be used including Unix, Linux, Windows, Macintosh OS, Google OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A system for generating audio, comprising:
a wearable component worn on a user's finger and including a motion detection component; and
a communication component; and
an audio generator, wherein the motion detection component detects motion by the user's finger and generates movement data, the communication component receiving the movement data from the motion detection component and transmitting the movement data to the audio generator, the audio generator generating audio in response to receiving the movement data.

2. The system of claim 1, wherein the wearable component includes a band worn on the user's finger.

3. The system of claim 1, wherein the audio generator includes an application for a mobile device

4. The system of claim 3, wherein the mobile device simultaneously outputs an audio signal in addition to the generated audio.

5. The system of claim 1, wherein the movement data is output via a wireless radio frequency signal.

6. The system of claim 1, wherein the movement data includes a direction of detected movement.

7. The system of claim 1, wherein the movement data includes a range of detected movement.

8. The system of claim 1, wherein the communication component includes one or more antennas for wirelessly communicating the movement data.
